(19) United States
(12) Patent Application Publication
(10) Pub. No.: US 2024/0169326 A1
(43) Pub. Date: May 23, 2024

(54) Methods and Systems for Enabling a Teacher to Provide Instruction on a Skill to a Learner

(71) Applicant: Blenheim Chalcot LTF Limited, London (GB)

(72) Inventors: Charles Stuart Mindenhall, London (GB); Josie Jane Filmer, London (GB); Lee Robert Arthur, Tampa, FL (US)

(73) Assignee: Blenheim Chalcot LTF Limited, London (GB)

(21) Appl. No.: 18/514,951

(22) Filed: Nov. 20, 2023

Related U.S. Application Data
(60) Provisional application No. 63/427,081, filed on Nov. 21, 2022.

(51) Int. Cl. G06Q 20/06; H04L 9/00

(52) U.S. Cl. CPC G06Q 20/065; H04L 9/50

(57) ABSTRACT

The problems of allowing organizations to more easily connect teachers with learners and facilitating knowledge transfer from the teachers to the learners is addressed by methods and systems that provides members/employees of an organization with personal wallets that contain funds. Members/employees provide instruction to one another, transferring funds from a wallet associated with the learner to a wallet associated with the teacher either before or after the instruction is provided. In some cases, feedback on the teacher's performance is collected and the amount of funds transferred to the teacher for providing the instruction to the learner is based on the feedback. In some cases, after the learner completes the instruction, a skills wallet associated with the learner is updated to show that the learner has received the instruction. In some cases, learner or teacher performance is displayed to the organization via a leaderboard or other performance display.

### CROSS-REFERENCE

The present application claims priority to U.S. Provisional Patent Application No. 63/427,081, entitled “METHODS AND SYSTEMS FOR ENABLING A TEACHER TO PROVIDE INSTRUCTION ON A SKILL TO A LEARNER,” filed on Nov. 21, 2022, which application is incorporated herein by reference in its entirety for all purposes.

### BACKGROUND OF THE INVENTION

Businesses and other organizations strive to implement learning cultures but find such a task difficult for a number of reasons discussed herein. Many organizations approach this problem by off-loading their learning and development needs to external training companies or content platforms that are both expensive and not very effective. For example, corporate training and informal peer to peer sessions often result in passive, one-way information transfer, an unintentional learning culture, low engagement, and low information retention. These approaches also neglect the fact that organizations themselves often have numerous internal experts who could provide training to their members.

However, tapping into this internal pool of expertise poses its own challenges. In particular, internal experts may lack the skills, confidence, or impetus to teach others within their organization, see little incentive or reward for doing so, or may not view teaching as part of their core work function. Moreover, members of the organization who need access to the internal experts' knowledge may not have a way to effectively access such knowledge when they need it. As such, there is a need for methods and systems that allow organizations to more easily connect teachers with learners and facilitate knowledge transfer from the teachers to the learners. These methods and systems would advantageously provide transparency to an organization by making internal expert knowledge accessible and its transfer to others both trackable and scalable. Such a tool would also benefit the organization by providing an ability to quantifiably capture or measure the impact of training efforts on the bottom line of the business.

### BRIEF DESCRIPTION OF THE DRAWINGS

Various embodiments of the invention are disclosed in the following detailed description and the accompanying drawings.

FIG. 1 shows a flowchart depicting an exemplary method for enabling a teacher to provide instruction on a skill to a learner.

FIG. 2 shows a flowchart depicting an exemplary method for enabling a learner to receive instruction on a skill from a teacher.

FIG. 3 shows a block diagram of a computer system for performing the method of FIGS. 1 and/or 2.

FIG. 4 is a block diagram of a system for performing the method of FIG. 1.

FIG. 5 is a block diagram of a system for performing the method of FIG. 2.

### DETAILED DESCRIPTION

The invention can be implemented in numerous ways, including as a process; an apparatus: a system; a composition of matter: a computer program product embodied on a computer readable storage medium: and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task.

As used herein, the term “processor” refers to one or more devices, circuits, and/or processing cores configured to process data, such as computer program instructions.

As used herein, the term “module” denotes a software component configured to implement a major function of a larger piece of software. For instance, a module may comprise a core component of a complex software system, a program that performs a core or essential function for other programs, a program that serves as the core foundation for a larger piece of software, a piece of software that is usually not found in isolation, or software that performs a specific or repetitive function. Classically, a module is packaged into a software library, though a module can also form part of an API. A module may alternatively be referred to as an “engine.”

As used herein, the term “or” denotes both inclusive and exclusive meanings. That is, the term “or” shall be understood as equivalent to the term “and/or.” For instance, “A or B” shall convey all possibilities of A alone, B alone, or A and B in combination.

As used herein, like numerals refer to like elements.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Businesses and other organizations often strive to implement learning cultures. A learning culture often features the following traits: learning is built into the core operating model and way of doing things: curiosity, respectful questioning and a desire to understand is encouraged, nurtured and developed: sharing one's knowledge with one's peers is celebrated and seen as part of doing one's job well. Such features create an environment which: enables and empowers people to adapt, pivot, and innovate: allows people to feel able to share feedback with each other and collectively continuously improve; and allows development of employee/member skills to get the most out of employees/members and enable them to grow with the organization.

Creating and embedding a learning culture is key to creating an effective environment for innovation and agile growth. Implementing a learning culture is very worthwhile. Research shows that companies who effectively nurture their workforce's desire to learn are at least 30% more likely to be market leaders in their industries over an extended period of time. However, creating such a learning culture is difficult to do and easy to deprioritize, especially since it is often difficult to prove that employees/members are actually learning and developing skills that impact the organization's bottom line. Further research shows that only 10% of organizations have managed to create a learning culture, with just 20% of employees demonstrating effective learning behaviors at work.

There are numerous factors that give rise to the difficulty of creating a learning culture within an organization. For instance, corporate training and informal peer to peer sessions are often provided as passive, one-way information transfers, resulting in an unintentional learning culture, low engagement, and low information retention. Alternatively, organizations often set up self-serve content platforms which often suffer from low employee/member engagement rates. These and similar approaches often suffer from the following drawbacks: reducing accountability on the learner to participate in and understand training, removing social elements which motivate learnings to show up to and engage with training, and removing the ability for teachers to understand their learners' needs. Thus, these approaches often prevent a learning culture from being instilled in the organization.

To more successfully implement learning cultures, organizations should realize that learning is fundamentally not about what is taught but rather about the value that it creates for learners. Thus, organizations should invest in providing training that leverages proven techniques. Many organizations approach this problem by off-loading their training to external training companies or external training content platforms. However, these companies and platforms are often very expensive and neglect the fact that organizations themselves often have numerous internal experts who could provide training to their members. Unfortunately, many of these experts lack the skills, confidence, or impetus to teach others within the organization or don't see teaching as part of their core work functions, and many members of the organization who need access to the internal experts' knowledge don't have a way to effectively access such knowledge when they need it.

As such, there is a need for methods and systems that allow organizations to more easily connect teachers with learners and facilitate knowledge transfer from the teachers to the learners. The methods and systems disclosed herein solve this problem using a platform that acts as a marketplace and enables employees/members to buy and sell training from and to one another. Such a platform provides teachers with a reason to provide training to learners and may help to better utilize the knowledge base within an organization. The platform may also provide a manner and forum for employees/members to train themselves, ensure that learning feels worthwhile and impactful, create learning cultures which praise, value, and reward the practice of sharing knowledge, enable organizations to harness the power of their own expertise, and enable organizations and their employees/members to keep track of training and the attendant return on investment.

The platform generally focuses on incentivizing and rewarding teachers for providing instruction to learners, thereby enticing greater numbers of members/employees in an organization to teach. Members/employees are provided with personal wallets that contain funds (such as tokens, coins, or other digital currencies). Such funds may be provided by the organization, allowing the organization to track its training spending. Members/employees are further provided with training on how to effectively instruct learners, increasing their effectiveness as teachers. Members/employees provide instruction to one another, transferring funds from a wallet associated with the learner to a wallet associated with the teacher either before or after the instruction is provided. In some cases, feedback on the teacher's performance is collected and the amount of funds transferred to the teacher for providing the instruction to the learner is based on the feedback. In this manner, teachers are incentivized to improve their teaching skills and engage with learners. In some cases, after the learner completes the instruction, a skills wallet associated with the learner is updated to show that the learner has received the instruction. In this manner, the organization can understand which members/employees have or lack particular skills or compare the skills or different members/employees. In some cases, learner or teacher performance is displayed to the organization via a leaderboard or other performance display.

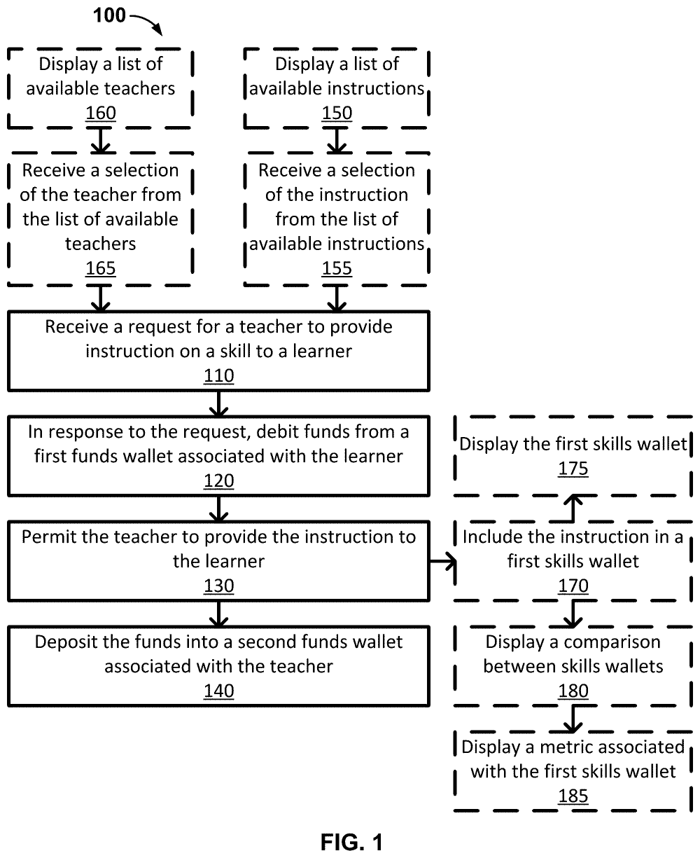

FIG. 1 shows a flowchart depicting an exemplary method 100 for enabling a teacher to provide instruction on a skill to a learner. In the example shown, a request for the teacher to provide the instruction to the learner is received at 110. In some embodiments, the teacher is an employee or member of a first organization, or otherwise associated therewith (e.g., a contractor for the first organization). In some embodiments, the learner is an employee or member of a second organization, or otherwise associated therewith (e.g., a contractor for the second organization).

In some embodiments, the first organization is a company, limited-liability company, corporation, partnership, non-profit organization, non-governmental organization, governmental organization, educational institution, research institution, or other organization. In some embodiments, the second organization is a company, limited-liability company, corporation, partnership, non-profit organization, non-governmental organization, governmental organization, educational institution, research institution, or other organization.

In some embodiments, the first organization and the second organization are the same. That is, in some embodiments, the teacher and the learner are members of or associated with the same organization, permitting a single organization to transfer knowledge from one employee or member to another internally. In other embodiments, the first organization and the second organization are different. That is, in some embodiments, the teacher and the learner are members of or associated with different organizations, permitting one organization to transfer knowledge from its employees or members to employees or members of another organization. In some embodiments, the first organization and the second organization are associated with one another. For instance, in some embodiments, the first organization and the second organization are related by a parent-subsidiary, partnership, collaborative, or other legal arrangement.

In some embodiments, the request is received from the learner himself or herself. That is, in some embodiments, the learner directly sends the request for the teacher to provide the instruction. In other embodiments, the request is received from the second organization. That is, in some embodiments, the second organization sends the request for the teacher to provide the instruction on behalf of or as an agent of the learner.

At 120, funds are debited from a first funds wallet associated with the learner in response to the request for the teacher to provide the instruction on the skill to the learner. In some embodiments, the funds are associated with a digital currency, coin, token, or the like. In some embodiments, the funds are registered on a ledger. In some embodiments, the ledger comprises a centralized ledger managed by a trusted intermediary. In some embodiments, the ledger comprises a decentralized ledger. In some embodiments, the funds are associated with a cryptocurrency, such as Bitcoin, Ethereum, Ripple, Cardano, Solano, Litecoin, Bitcoin Cash, Binance Coin, or the like. In some embodiments, the funds are associated with a physical electronic funds transfer system, such as a card-based (e.g., debit or credit card-based) electronic funds transfer system.

At 130, the teacher is permitted to provide the instruction to the learner. In some embodiments, 120 occurs before 130. That is, in some embodiments, the funds are debited from the first funds wallet prior to permitting the teacher to provide the instruction to the learner. In other embodiments, 130 occurs before 120. That is, in some embodiments, the teacher is permitted to provide the instruction to the learner prior to debiting the funds from the first funds wallet. In some embodiments, permitting the teacher to provide the instruction prior to debiting the funds allows the learner to provide feedback regarding the instruction (such as the usefulness of the instruction, the quality of instruction delivered by the teacher, or the like) before paying the funds for the instruction. This may incentivize the teacher to provide better instruction to the learner.

At 140, the funds are deposited into a second funds wallet associated with the teacher. In some embodiments, 130 occurs before 140. That is, in some embodiments, the teacher is permitted to provide the instruction to the learner prior to depositing the funds into the second funds wallet. In some embodiments, permitting the teacher to provide the instruction prior to depositing the funds into the second funds wallet allows the learner to provide feedback regarding the instruction (such as the usefulness of the instruction, the quality of instruction delivered by the teacher, or the like) before the funds are transferred to the teacher. This may incentivize the teacher to provide better instruction to the learner. In other embodiments, 140 occurs before 130. That is, in some embodiments, the funds are deposited into the second funds wallet prior to permitting the teacher to provide the instruction to the learner.

In some embodiments, an amount of funds that is debited from the first funds wallet and deposited to the second funds wallet is based at least in part on feedback regarding the instruction. That is, in some embodiments, the amount of funds provided to the teacher for providing the instruction is correlated with feedback regarding the usefulness of the instruction, the quality of instruction delivered by the teacher, or the like. This may incentivize the teacher to provide better instruction by motivating the teacher to seek greater compensation for improved teaching. Alternatively or in combination, this may incentivize the teacher to provide different instruction by motivating the teacher to provide instruction on skills that are more useful. In some embodiments, the feedback is received from the particular learner from whom funds are transferred to the teacher. In other embodiments, the feedback is received from all or a portion of other learners who have previously received the instruction from the teacher.

At 150, a list of available instructions is optionally displayed to the learner. In some embodiments, the list of available instructions comprises the instruction provided by the teacher to the learner. In some embodiments, the list of available instructions is presented to the learner in the form of a drop-down menu, list, electronic catalog, or the like. In some embodiments, the list of available instructions comprises information regarding the subject matter, content, length, or difficulty of each available instruction, or the like. In some embodiments, the list of available instructions is displayed to the learner prior to 110.

At 155, a selection of the instruction from the list of available instructions is optionally received from the learner or the second organization.

At 160, a list of available teachers is optionally displayed to the learner. In some embodiments, the list of available teachers comprises the teacher who provides the instruction to the learner. In some embodiments, the list of available teachers is presented to the learner in the form of a drop-down menu, list, electronic catalog, or the like. In some embodiments, the list of available teachers comprises information regarding the biography, experience, or teaching ability of each available teacher, or the like. In some embodiments, the list of available teachers is displayed to the learner prior to 110.

At 165, a selection of the teacher from the list of available teachers is optionally received from the learner or the second organization.

At 170, the instruction is optionally included in a first skills wallet associated with the learner. In some embodiments, the first skills wallet comprises a list of instructions that the learner has taken, a list of skills on which the learner has been given instruction, or the like. In some embodiments, the first skills wallet allows tracking of the learner's instructions or skills by the organization of which the learner is a member, employee, or otherwise affiliated.

At 175, the first skills wallet is optionally displayed to a member of the first organization or the second organization. In some embodiments, the member is the learner. In some embodiments, the member is someone other than the learner. For instance, in some embodiments, the member is a supervisor of the learner or a manager of the learner. In some embodiments, displaying the first skills wallet to the member allows the member to identify the learner's areas of strength or weakness. In some embodiments, displaying the first skills wallet to the member allows the member to develop a training regimen to enhance the learner's skills or compare the learner's skills with a previously developed training regimen.

In some embodiments, the member is the teacher. In some embodiments, the member is someone other than the teacher. For instance, in some embodiments, the member is a supervisor of the teacher or a manager of the teacher. In some embodiments, displaying the first skills wallet to the member allows the member to identify the teacher's or learner's areas of strength or weakness. In some embodiments, displaying the first skills wallet to the member allows the member to develop a training regimen to enhance the teacher's or learner's skills or compare the teacher's or learner's skills with a previously developed training regimen.

At 180, a comparison between the first skills wallet and at least one second skills wallet is optionally displayed to a member of the first organization or the second organization. In some embodiments, the second skills wallet is associated with another member, employee, or affiliate of the second organization. In some embodiments, the member is the learner. In some embodiments, the member is someone other than the learner. For instance, in some embodiments, the member is a supervisor of the learner or a manager of the learner. In some embodiments, the comparison allows the member to compare the learner's skills with those of other employees, members, or other affiliates of the second organization. In some embodiments, the comparison allows the member to identify the learner's areas of strength or weakness in comparison to other employees, members, or other affiliates of the second organization. In some embodiments, the comparison allows the member to identify the second organization's areas of strength or weakness as a whole.

In some embodiments, the second skills wallet is associated with another member, employee, or affiliate of the first organization. In some embodiments, the member is the teacher. In some embodiments, the member is someone other than the teacher. For instance, in some embodiments, the member is a supervisor of the teacher or a manager of the teacher. In some embodiments, the comparison allows the member to compare the learner's or teacher's skills with those of other employees, members, or other affiliates of the first organization or the second organization. In some embodiments, the comparison allows the member to identify the learner's or teacher's areas of strength or weakness in comparison to other employees, members, or other affiliates of the first organization or the second organization. In some embodiments, the comparison allows the member to identify the first organization's or the second organization's areas of strength or weakness as a whole.

In some embodiments, the comparison is between the first skills wallet and a plurality of second skills wallets. In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more second skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 second skills wallets. In some embodiments, the comparison is between the first skills wallet and a number of second skills wallets that is within a range defined by any two of the preceding values.

At 185, a metric associated with the first skills wallet is optionally displayed to a member of the first organization or the second organization. In some embodiments, the metric is based on a comparison between the first skills wallet and a plurality of other skills wallets.

In some embodiments, the plurality of other skills wallets are associated with other members, employees, or affiliates of the second organization. In some embodiments, the member is the learner. In some embodiments, the member is someone other than the learner. For instance, in some embodiments, the member is a supervisor of the learner or a manager of the learner. In some embodiments, the metric allows the member to quickly or accurately compare the learner's skills with those of other employees, members, or other affiliates of the second organization. In this manner, the metric may perform a similar role as a credit score performs in allowing a lender to make lending decisions. That is, in some embodiments, the metric allows the member to quickly and accurately determine how well the learner's skills are matched to their current role, roles to which they are being considered for promotion, and the like.

In some embodiments, the second skills wallet is associated with another member, employee, or affiliate of the first organization. In some embodiments, the member is the teacher. In some embodiments, the member is someone other than the teacher. For instance, in some embodiments, the member is a supervisor of the teacher or a manager of the teacher. In some embodiments, the metric allows the member to quickly or accurately compare the teacher's skills with those of other employees, members, or other affiliates of the first organization or the second organization. Thus, the metric may allow the member to quickly and accurately determine how well the teacher's skills are matched to their current teaching role, teaching roles for which they are being considered, and the like.

In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more other skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 other skills wallets. In some embodiments, the comparison is between the first skills wallet and a number of other skills wallets that is within a range defined by any two of the preceding values.

In some embodiments, all or a portion of method 100 (such as any one or more of operations 110, 120, 130, 140, 150, 155, 160, 165, 170, 175, 180, or 185) is repeated one or more times. In some embodiments, all or a portion of method 100 is repeated for different learners or teachers.

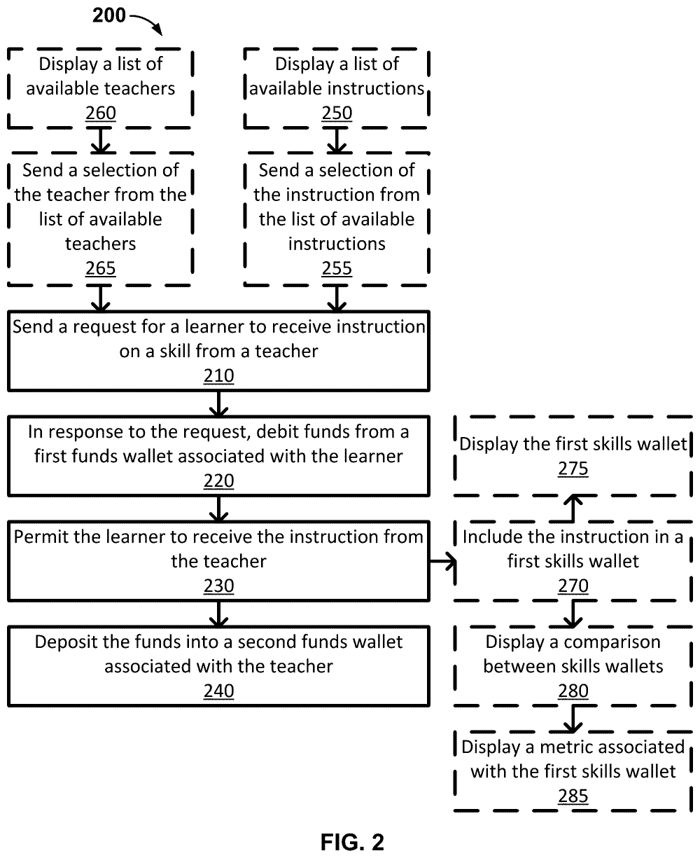

FIG. 2 shows a flowchart depicting an exemplary method 200 for enabling a learner to receive instruction on a skill from a teacher. In the example shown, a request for the learner to receive the instruction from the teacher is sent at 210. In some embodiments, the teacher is an employee or member of a first organization, or otherwise associated therewith (e.g., a contractor for the first organization), as described herein with respect to operation 110 of FIG. 1. In some embodiments, the learner is an employee or member of a second organization, or otherwise associated therewith (e.g., a contractor for the second organization), as described herein with respect to operation 110 of FIG. 1.

In some embodiments, the first organization is any first organization described herein with respect to operation 110 of FIG. 1. In some embodiments, the second organization is any second organization described herein with respect to operation 110 of FIG. 1.

In some embodiments, the first organization and the second organization are the same, as described herein with respect to operation 110 of FIG. 1. In other embodiments, the first organization and the second organization are different, as described herein with respect to operation 110 of FIG. 1.

In some embodiments, the request is sent by the learner himself or herself. That is, in some embodiments, the learner directly sends the request for the teacher to provide the instruction. In other embodiments, the request is sent by the second organization. That is, in some embodiments, the second organization sends the request for the teacher to provide the instruction on behalf of or as an agent of the learner.

At 220, funds are debited from a first funds wallet associated with the learner in response to the request for the learner to receive the instruction on the skill from the teacher. In some embodiments, the funds comprise any funds described herein with respect to operation 120 of FIG. 1.

At 230, the learner is permitted to receive the instruction from the learner. In some embodiments, 220 occurs before 230. That is, in some embodiments, the funds are debited from the first funds wallet prior to permitting the learner to receive the instruction from the teacher. In other embodiments, 230 occurs before 220. That is, in some embodiments, the learner is permitted to receiver the instruction from the teacher prior to debiting the funds from the first funds wallet. In some embodiments, permitting the learner to receive the instruction prior to debiting the funds provides any of the advantages described herein with respect to operation 130 of FIG. 1.

At 240, the funds are deposited into a second funds wallet associated with the teacher. In some embodiments, 230 occurs before 240. That is, in some embodiments, the learner is permitted to receive the instruction from the teacher prior to depositing the funds into the second funds wallet. In some embodiments, permitting the learner to receive the instruction prior to depositing the funds into the second funds wallet provides any of the advantages described herein with respect to operation 140 of FIG. 1. In other embodiments, 240 occurs before 230. That is, in some embodiments, the funds are deposited into the second funds wallet prior to permitting the learner to receive the instruction from the teacher.

In some embodiments, an amount of funds that is debited from the first funds wallet and deposited to the second funds wallet is based at least in part on feedback regarding the instruction, as described herein with respect to operation 140 of FIG. 1. In some embodiments, the feedback comprises any feedback described herein with respect to operation 140 of FIG. 1.

At 250, a list of available instructions is optionally displayed to the learner. In some embodiments, the list of available instructions comprises any list of available instructions described herein with respect to operation 150 of FIG. 1. In some embodiments, the list of available instructions is displayed to the learner prior to 210.

At 255, a selection of the instruction from the list of available instructions is optionally sent by the learner or the second organization.

At 260, a list of available teachers is optionally displayed to the learner. In some embodiments, the list of available teachers comprises any list of available teachers described herein with respect to operation 160 of FIG. 1. In some embodiments, the list of available teachers is displayed to the learner prior to 210.

At 265, a selection of the teacher from the list of available teachers is optionally sent from the learner or the second organization.

At 270, the instruction is optionally included in a first skills wallet associated with the learner. In some embodiments, the first skills wallet comprises any first skills wallet described herein with respect to operation 170 of FIG. 1.

At 275, the first skills wallet is optionally displayed to a member of the first organization or the second organization. In some embodiments, the member comprises any member described herein with respect to operation 175 of FIG. 1.

At 280, a comparison between the first skills wallet and at least one second skills wallet is optionally displayed to a member of the first organization or the second organization. In some embodiments, the second skills wallet comprises any second skills wallet described herein with respect to operation 180 of FIG. 1. In some embodiments, the member comprises any member described herein with respect to operation 180 of FIG. 1.

In some embodiments, the second skills wallet is associated with another member, employee, or affiliate of the first organization, as described herein with respect to operation 180 of FIG. 1. In some embodiments, the member comprises any member described herein with respect to operation 180 of FIG. 1.

In some embodiments, the comparison is between the first skills wallet and a plurality of second skills wallets. In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more second skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 second skills wallets. In some embodiments, the comparison is between the first skills wallet and a number of second skills wallets that is within a range defined by any two of the preceding values.

At 285, a metric associated with the first skills wallet is optionally displayed to a member of the first organization or the second organization. In some embodiments, the metric is based on a comparison between the first skills wallet and a plurality of other skills wallets, as described herein with respect to operation 185 of FIG. 1. In some embodiments, the plurality of other skills wallets is associated with other members, employees, or affiliates of the first organization or second organization, as described herein with respect to operation 185 of FIG. 1. In some embodiments, the member comprises any member described herein with respect to operation 185 of FIG. 1.

In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more other skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 other skills wallets. In some embodiments, the comparison is between the first skills wallet and a number of other skills wallets that is within a range defined by any two of the preceding values.

In some embodiments, all or a portion of method 200 (such as any one or more of operations 210, 220, 230, 240, 250, 255, 260, 265, 270, 275, 280, or 285) is repeated one or more times. In some embodiments, all or a portion of method 200 is repeated for different learners or teachers.

Additionally, systems for enabling a teacher to provide instruction on a skill to a learner (or enabling a learner to receive instruction on a skill) are disclosed that can be used to perform the method 100 of FIG. 10r the method 200 of FIG. 2 as described above. In some embodiments, the systems comprise one or more processors and memory coupled to the one or more processors. In some embodiments, the one or more processors are configured to implement the operations of method 100 (or any one or more of operations 110, 120, 130, 140, 150, 155, 160, 165, 170, 175, 180, or 185). In some embodiments, the memory is configured to provide the one or more processors with instructions corresponding to the operations of method 100 (or any one or more of operations 110, 120, 130, 140, 150, 155, 160, 165, 170, 175, 180, or 185). In some embodiments, the one or more processors are configured to implement the operations of method 200 (or any one or more of operations 210, 220, 230, 240, 250, 255, 260, 265, 270, 275, 280, or 285). In some embodiments, the memory is configured to provide the one or more processors with instructions corresponding to the operations of method 200 (or any one or more of operations 210, 220, 230, 240, 250, 255, 260, 265, 270, 275, 280, or 285). In some embodiments, the instructions are embodied in a tangible computer readable storage medium.

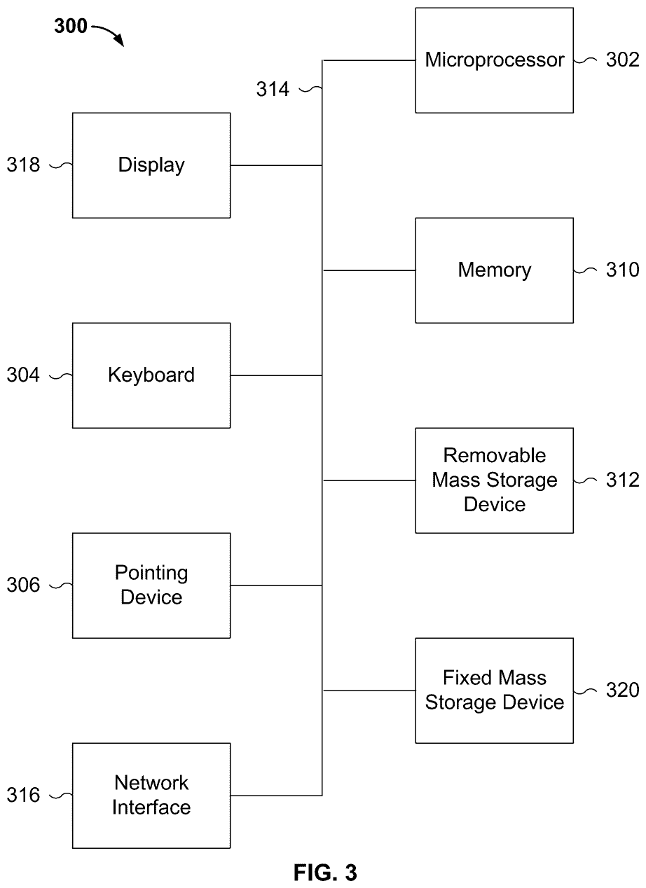

FIG. 3 is a block diagram of a computer system 300 used in some embodiments to perform methods for enabling a teacher to provide instruction on a skill to a learner (or enabling a learner to receive instruction on a skill) described herein. In some embodiments, computer system 300 is used to perform method 100 as described herein with respect to FIG. 1 (or any one or more of operations 110, 120, 130, 140, 150, 155, 160, 165, 170, 175, 180, or 185). In some embodiments, computer system 300 is used to perform method 200 as described herein with respect to FIG. 2 (or any one or more of operations 210, 220, 230, 240, 250, 255, 260, 265, 270, 275, 280, or 285).

FIG. 3 illustrates one embodiment of a general purpose computer system. Other computer system architectures and configurations can be used for carrying out the processing of the present invention. Computer system 300, made up of various subsystems described below, includes at least one microprocessor subsystem 302. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 300. Using instructions retrieved from memory 310, the microprocessor subsystem controls the reception and manipulation of input data, and the output and display of data on output devices.

The microprocessor subsystem 302 is coupled bi-directionally with memory 310, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 310 may include any suitable computer-readable storage media, described below, depending on whether, for example, data access needs to be bi-directional or uni-directional. The microprocessor subsystem 302 can also directly and very rapidly retrieve and store frequently needed data in a cache memory (not shown).

A removable mass storage device 312 provides additional data storage capacity for the computer system 300, and is coupled either bi-directionally (read/write) or uni-directionally (read only) to microprocessor subsystem 302. Storage device 312 may also include computer-readable media such as magnetic tape, flash memory, signals embodied on a carrier wave, PC-CARDS, portable mass storage devices, holographic storage devices, and other storage devices. A fixed mass storage 320 can also provide additional data storage capacity. The most common example of mass storage 320 is a hard disk drive. Mass storage 312 and 320 generally store additional programming instructions, data, and the like that typically are not in active use by the processing subsystem. It will be appreciated that the information retained within mass storage 312 and 320 may be incorporated, if needed, in standard fashion as part of primary storage 310 (e.g. RAM) as virtual memory.

In addition to providing processing subsystem 302 access to storage subsystems, bus 314 can be used to provide access other subsystems and devices as well. In the described embodiment, these can include a display monitor 318, a network interface 316, a keyboard 304, and a pointing device 306, as well as an auxiliary input/output device interface, a sound card, speakers, and other subsystems as needed. The pointing device 306 may be a mouse, stylus, track ball, or tablet, and is useful for interacting with a graphical user interface.

The network interface 316 allows the processing subsystem 302 to be coupled to another computer, computer network, or telecommunications network using a network connection as shown. Through the network interface 316, it is contemplated that the processing subsystem 302 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 302 can be used to connect the computer system 300 to an external network and transfer data according to standard protocols. That is, method embodiments of the present invention may execute solely upon processing subsystem 302, or may be performed across a network such as the Internet, intranet networks, or local area networks, in conjunction with a remote processing subsystem that shares a portion of the processing. Additional mass storage devices (not shown) may also be connected to processing subsystem 302 through network interface 316.

An auxiliary I/O device interface (not shown) can be used in conjunction with computer system 300. The auxiliary I/O device interface can include general and customized interfaces that allow the processing subsystem 302 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter.

The computer system shown in FIG. 3 is but an example of a computer system suitable for use with the inventions. Other computer systems suitable for use with the invention may include additional or fewer subsystems. In addition, bus 314 is illustrative of any interconnection scheme serving to link the subsystems. Other computer architectures having different configurations of subsystems may also be utilized.

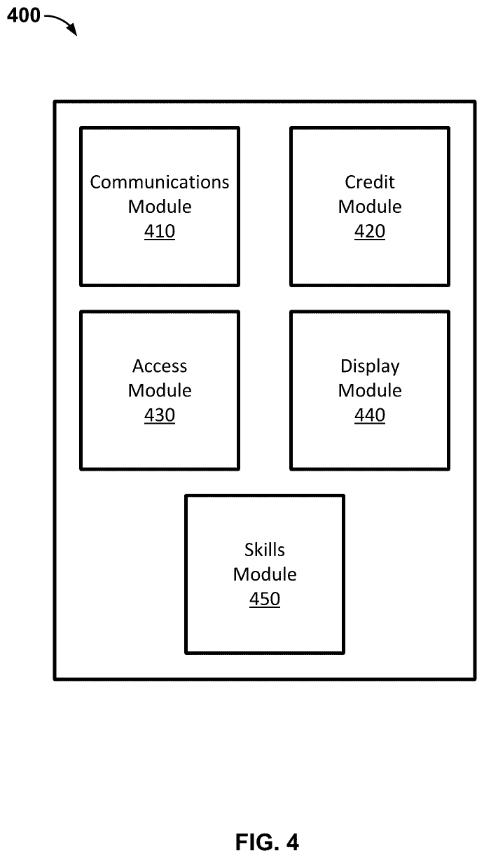

FIG. 4 is a block diagram of a system 400 used in some embodiments to perform methods for enabling a teacher to provide instruction on a skill to a learner described herein. In some embodiments, system 400 is used to perform method 100 as described herein with respect to FIG. 1 (or any one or more of operations 110, 120, 130, 140, 150, 155, 160, 165, 170, 175, 180, or 185). In some embodiments, the system 400 is implemented as software to be executed by a computer system, such as computer system 300 described herein with respect to FIG. 3.

In the example shown, system 400 comprises a communications module 410. In some embodiments, the communications module is configured to implement operation 110 described herein with respect to FIG. 1. That is, in some embodiments, the communications module is configured to receive a request for the teacher to provide the instruction on the skill to the learner.

In some embodiments, the teacher is an employee or member of a first organization, or otherwise associated therewith (e.g., a contractor for the first organization), as described herein with respect to operation 110 of FIG. 1. In some embodiments, the learner is an employee or member of a second organization, or otherwise associated therewith (e.g., a contractor for the second organization), as described herein with respect to operation 110 of FIG. 1.

In some embodiments, the first organization is any first organization described herein with respect to operation 110 of FIG. 1. In some embodiments, the second organization is any second organization described herein with respect to operation 110 of FIG. 1.

In some embodiments, the first organization and the second organization are the same, as described herein with respect to operation 110 of FIG. 1. In other embodiments, the first organization and the second organization are different, as described herein with respect to operation 110 of FIG. 1.

In some embodiments, the request is received from the learner himself or herself. That is, in some embodiments, the learner directly sends the request for the teacher to provide the instruction. In other embodiments, the request is received from the second organization. That is, in some embodiments, the second organization sends the request for the teacher to provide the instruction on behalf of or as an agent of the learner.

In the example shown, the system 400 further comprises a credit module 420. In some embodiments, the credit module is configured to implement operation 120 described herein with respect to FIG. 1. That is, in some embodiments, the credit module is configured to, in response to the request, debit funds from a first funds wallet associated with the learner.

In some embodiments, the funds comprise any funds described herein with respect to operation 120 of FIG. 1.

In the example shown, the system further comprises an access module 430. In some embodiments, the access module is configured to implement operation 130 described herein with respect to FIG. 1. That is, in some embodiments, the access module is configured to permit the teacher to provide the instruction to the learner. In some embodiments, the funds are debited from the first funds wallet prior to permitting the teacher to provide the instruction to the learner. In other embodiments, the teacher is permitted to provide the instruction to the learner prior to debiting the funds from the first funds wallet. In some embodiments, permitting the teacher to provide the instruction prior to debiting the funds provides any of the advantages described herein with respect to operation 130 of FIG. 1.

In some embodiments, the credit module 420 is further configured to implement operation 140 described herein with respect to FIG. 1. That is, in some embodiments, the credit module is configured to deposit the funds into a second funds wallet associated with the teacher. In some embodiments, the teacher is permitted to provide the instruction to the learner prior to depositing the funds into the second funds wallet. In some embodiments, permitting the teacher to provide the instruction prior to depositing the funds into the second funds wallet provides any of the advantages described herein with respect to operation 140 of FIG. 1. In other embodiments, the funds are deposited into the second funds wallet prior to permitting the teacher to provide the instruction to the learner.

In some embodiments, an amount of funds that is debited from the first funds wallet and deposited to the second funds wallet is based at least in part on feedback regarding the instruction, as described herein with respect to operation 140 of FIG. 1. In some embodiments, the feedback comprises any feedback described herein with respect to operation 140 of FIG. 1.

In some embodiments, the system 400 further comprises a display module 440. In some embodiments, the display module is configured to implement operation 150 described herein with respect to FIG. 1. That is, in some embodiments, the display module is optionally configured to display a list of available instructions to the learner. In some embodiments, the list of available instructions comprises any list of available instructions described herein with respect to operation 150 of FIG. 1. In some embodiments, the list of available instructions is displayed to the learner prior to receiving the request for the teacher to provide the instruction to the learner.

In some embodiments, the communications module 410 is further configured to implement operation 155 described herein with respect to FIG. 1. That is, in some embodiments, the communications module is configured to receive, from the learner, a selection of the instruction from the list of available instructions.

In some embodiments, the display module 440 is further configured to implement operation 160 described herein with respect to FIG. 1. That is, in some embodiments, the display module is optionally configured to display a list of available teachers to the learner. In some embodiments, the list of available teachers comprises any list of available teachers described herein with respect to operation 160 of FIG. 1. In some embodiments, the list of available teachers is displayed to the learner prior to receiving the request for the teacher to provide the instruction to the learner.

In some embodiments, the communications module 410 is further configured to implement operation 165 described herein with respect to FIG. 1. That is, in some embodiments, the communications module is configured to receive, from the learner, a selection of the teacher from the list of available teachers.

In some embodiments, the system 400 further comprises a skills module 450. In some embodiments, the skills module is configured to implement operation 170 described herein with respect to FIG. 1. That is, in some embodiments, the skills module is configured to include the instruction in a first skills wallet associated with the learner. In some embodiments, the first skills wallet comprises any first skills wallet described herein with respect to operation 170 of FIG. 1.

In some embodiments, the skills module 450 is further configured to implement operation 175 described herein with respect to FIG. 1. That is, in some embodiments, the skills module is configured to display, to a member of the first organization or the second organization, the first skills wallet. In some embodiments, the member comprises any member described herein with respect to operation 175 of FIG. 1

In some embodiments, the skills module 450 is further configured to implement operation 180 described herein with respect to FIG. 1. That is, in some embodiments, the skills module is configured to display, to a member of the first organization or the second organization, a comparison between the first skills wallet and at least one second skills wallet associated with another member of the second organization. In some embodiments, the member comprises any member described herein with respect to operation 180 of FIG. 1.

In some embodiments, the second skills wallet is associated with another member, employee, or affiliate of the first organization, as described herein with respect to operation 180 of FIG. 1. In some embodiments, the member comprises any member described herein with respect to operation 180 of FIG. 1.

In some embodiments, the comparison is between the first skills wallet and a plurality of second skills wallets. In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more second skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 second skills wallets. In some embodiments, the comparison is between the first skills wallet and a number of second skills wallets that is within a range defined by any two of the preceding values.

In some embodiments, the skills module 450 is further configured to implement operation 185 described herein with respect to FIG. 1. That is, in some embodiments, the skills module is configured to display, to a member of the first organization or the second organization, a metric associated with the first skills wallet. In some embodiments, the metric is based on a comparison between the first skills wallet and a plurality of other skills wallets, as described herein with respect to operation 185 of FIG. 1. In some embodiments, the plurality of other skills wallets is associated with other members, employees, or affiliates of the first organization or second organization, as described herein with respect to operation 185 of FIG. 1. In some embodiments, the member comprises any member described herein with respect to operation 185 of FIG. 1.

In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more other skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 other skills wallets. In some embodiments, the comparison is between the first skills wallet and a number of other skills wallets that is within a range defined by any two of the preceding values.

In some embodiments, system 400 (or any one or more of modules 410, 420, 430, 440, and 450) is configured to perform all or a portion of method 100 (such as any one or more of operations 110, 120, 130, 140, 150, 155, 160, 165, 170, 175, 180, or 185) one or more times. In some embodiments, system 400 (or any one or more of modules 410, 420, 430, 440, and 450) is configured to repeat all or a portion of method 100 for different learners or teachers.

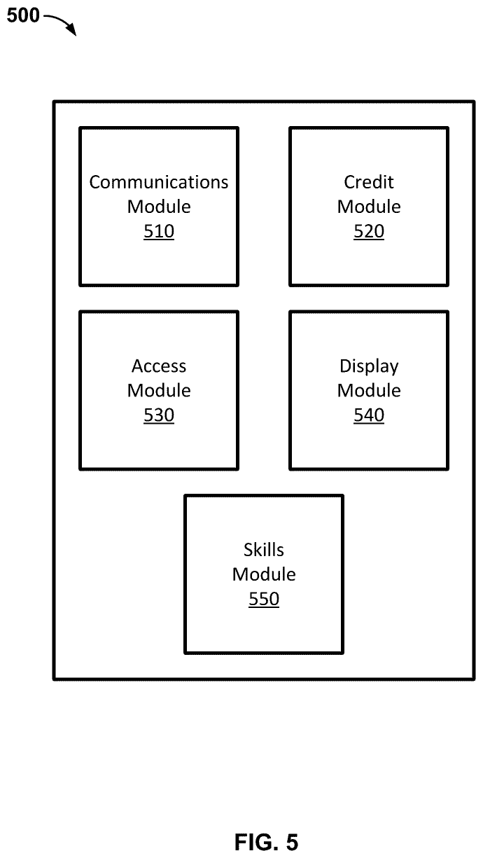

FIG. 5 is a block diagram of a system 500 used in some embodiments to perform methods for enabling a learner to receive instruction on a skill from a teacher described herein. In some embodiments, system 500 is used to perform method 200 as described herein with respect to FIG. 2 (or any one or more of operations 210, 220, 230, 240, 250, 255, 260, 265, 270, 275, 280, or 285). In some embodiments, the system 500 is implemented as software to be executed by a computer system, such as computer system 300 described herein with respect to FIG. 3.

In the example shown, system 500 comprises a communications module 510. In some embodiments, the communications module is configured to implement operation 210 described herein with respect to FIG. 2. That is, in some embodiments, the communications module is configured to send a request for the learner to receive the instruction on the skill from the teacher.

In some embodiments, the teacher is an employee or member of a first organization, or otherwise associated therewith (e.g., a contractor for the first organization), as described herein with respect to operation 210 of FIG. 2. In some embodiments, the learner is an employee or member of a second organization, or otherwise associated therewith (e.g., a contractor for the second organization), as described herein with respect to operation 210 of FIG. 2.

In some embodiments, the first organization is any first organization described herein with respect to operation 210 of FIG. 2. In some embodiments, the second organization is any second organization described herein with respect to operation 210 of FIG. 2.

In some embodiments, the first organization and the second organization are the same, as described herein with respect to operation 210 of FIG. 2. In other embodiments, the first organization and the second organization are different, as described herein with respect to operation 210 of FIG. 2.

In some embodiments, the request is sent by the learner himself or herself. That is, in some embodiments, the learner directly sends the request for the teacher to provide the instruction. In other embodiments, the request is sent by the second organization. That is, in some embodiments, the second organization sends the request for the teacher to provide the instruction on behalf of or as an agent of the learner.

In the example shown, the system 500 further comprises a credit module 520. In some embodiments, the credit module is configured to implement operation 220 described herein with respect to FIG. 2. That is, in some embodiments, the credit module is configured to, in response to the request, debit funds from a first funds wallet associated with the learner.

In some embodiments, the funds comprise any funds described herein with respect to operation 220 of FIG. 2.

In the example shown, the system further comprises an access module 530. In some embodiments, the access module is configured to implement operation 530 described herein with respect to FIG. 2. That is, in some embodiments, the access module is configured to permit the learner to receive the instruction from the teacher. In some embodiments, the funds are debited from the first funds wallet prior to permitting the learner to receive the instruction from the teacher. In other embodiments, the learner is permitted to receive the instruction from the teacher prior to debiting the funds from the first funds wallet. In some embodiments, permitting the learner to receive the instruction prior to debiting the funds provides any of the advantages described herein with respect to operation 230 of FIG. 2.

In some embodiments, the credit module 520 is further configured to implement operation 240 described herein with respect to FIG. 2. That is, in some embodiments, the credit module is configured to deposit the funds into a second funds wallet associated with the teacher. In some embodiments, the learner is permitted to receive the instruction from the teacher prior to depositing the funds into the second funds wallet. In some embodiments, permitting the learner to receive the instruction prior to depositing the funds into the second funds wallet provides any of the advantages described herein with respect to operation 240 of FIG. 2. In other embodiments, the funds are deposited into the second funds wallet prior to permitting the learner to receive the instruction from the teacher.

In some embodiments, an amount of funds that is debited from the first funds wallet and deposited to the second funds wallet is based at least in part on feedback regarding the instruction, as described herein with respect to operation 240 of FIG. 2. In some embodiments, the feedback comprises any feedback described herein with respect to operation 240 of FIG. 2.

In some embodiments, the system 500 further comprises a display module 540. In some embodiments, the display module is configured to implement operation 250 described herein with respect to FIG. 2. That is, in some embodiments, the display module is optionally configured to display a list of available instructions to the learner. In some embodiments, the list of available instructions comprises any list of available instructions described herein with respect to operation 250 of FIG. 2. In some embodiments, the list of available instructions is displayed to the learner prior to receiving the request for the learner to receive the instruction from the teacher.

In some embodiments, the communications module 510 is further configured to implement operation 255 described herein with respect to FIG. 2. That is, in some embodiments, the communications module is configured to send, from the learner, a selection of the instruction from the list of available instructions.

In some embodiments, the display module 540 is further configured to implement operation 260 described herein with respect to FIG. 2. That is, in some embodiments, the display module is optionally configured to display a list of available teachers to the learner. In some embodiments, the list of available teachers comprises any list of available teachers described herein with respect to operation 260 of FIG. 2. In some embodiments, the list of available teachers is displayed to the learner prior to receiving the request for the learner to receive the instruction from the teacher.

In some embodiments, the communications module 510 is further configured to implement operation 265 described herein with respect to FIG. 2. That is, in some embodiments, the communications module is configured to send, from the learner, a selection of the teacher from the list of available teachers.

In some embodiments, the system 500 further comprises a skills module 550. In some embodiments, the skills module is configured to implement operation 270 described herein with respect to FIG. 2. That is, in some embodiments, the skills module is configured to include the instruction in a first skills wallet associated with the learner. In some embodiments, the first skills wallet comprises any first skills wallet described herein with respect to operation 270 of FIG. 2.

In some embodiments, the skills module 550 is further configured to implement operation 275 described herein with respect to FIG. 2. That is, in some embodiments, the skills module is configured to display, to a member of the first organization or the second organization, the first skills wallet. In some embodiments, the member comprises any member described herein with respect to operation 275 of FIG. 2

In some embodiments, the skills module 550 is further configured to implement operation 280 described herein with respect to FIG. 2. That is, in some embodiments, the skills module is configured to display, to a member of the first organization or the second organization, a comparison between the first skills wallet and at least one second skills wallet associated with another member of the second organization. In some embodiments, the member comprises any member described herein with respect to operation 280 of FIG. 2.

In some embodiments, the second skills wallet is associated with another member, employee, or affiliate of the first organization, as described herein with respect to operation 280 of FIG. 2. In some embodiments, the member comprises any member described herein with respect to operation 280 of FIG. 2.

In some embodiments, the comparison is between the first skills wallet and a plurality of second skills wallets. In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more second skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 second skills wallets. In some embodiments, the comparison is between the first skills wallet and a number of second skills wallets that is within a range defined by any two of the preceding values.

In some embodiments, the skills module 550 is further configured to implement operation 285 described herein with respect to FIG. 2. That is, in some embodiments, the skills module is configured to display, to a member of the first organization or the second organization, a metric associated with the first skills wallet. In some embodiments, the metric is based on a comparison between the first skills wallet and a plurality of other skills wallets, as described herein with respect to operation 285 of FIG. 2. In some embodiments, the plurality of other skills wallets is associated with other members, employees, or affiliates of the first organization or second organization, as described herein with respect to operation 285 of FIG. 2. In some embodiments, the member comprises any member described herein with respect to operation 285 of FIG. 2.

In some embodiments, the comparison is between the first skills wallet and at least 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more other skills wallets. In some embodiments, the comparison is between the first skills wallet and at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 other skills wallets. In some embodiments, the comparison is between the first skills wallet and a number of other skills wallets that is within a range defined by any two of the preceding values.

In some embodiments, system 500 (or any one or more of modules 510, 520, 530, 540, and 550) is configured to perform all or a portion of method 200 (such as any one or more of operations 210, 220, 230, 240, 250, 255, 260, 265, 270, 275, 280, or 285) one or more times. In some embodiments, system 500 (or any one or more of modules 510, 520, 530, 540, and 550) is configured to repeat all or a portion of method 200 for different learners or teachers.

### EXAMPLES

### Example 1: Coin-Based Learner and Teaching Interfaced with Thinkific

A coin-based system for enabling a teacher to provide instruction on a skill to a learner and a learner to receive instruction on the skill from the teacher was implemented and interfaced with the Thinkific learning platform. The system was designed to enable learners from a venture capital (VC)-backed company to receive instruction featured on the Thinkific platform. At the outset, the VC-company was allowed to purchase subscriptions to the system for up to 20 employees. The subscription payment was made to the VC. Upon payment, a confirmation email was sent, the learner onboarding process began, and digital coins (Skill Coins) were added to a wallet associated with the learner. The learner's wallet balance was tracked by a Skill Coins app. In parallel, a new cohort was created for the up to 20 employees in the Thinkific platform. Thinkific courses were made available to the cohort. Individual instruction sessions for the cohort were then created for the cohort.

If a learner in the cohort was not already a Thinkific user, a learner account was created on Thinkific. A new account email was then triggered and sent to the learner, prompting the learner to set up an account and password. Once this process had taken place, the learner was able to login to Thinkific as a member of the cohort. If, instead, the learner was already a Thinkific user, the learner was enrolled or added to their respective cohort within Thinkific. Skill Coins were added to the learner's wallet within the Skill Coins app.

A diary hold was then sent to all learners in the cohort and emails were sent to block off the learners' calendars with direct links to each instruction the learners were to receive. Nudge emails with direct links to each instruction on the Thinkific platform were then sent one day and one hour before each instruction. By clicking on the link, a learner was prompted to log into the Thinkific platform and then taking to a training page for the corresponding instruction. The learner then started and completed the instruction and submitted a form to confirm their attendance at the instruction.

The Thinkific software then sent a Webhook to the Skill Coins app, notifying the Skill Coins app that the learner had successfully completed the instruction. The Skill Coins App then cross-referenced the number of Skill Coins to be deducted from the learner's wallet based on values set for each instruction by the Skill Coins app administrator.

Upon completion of the instruction, the learner was enabled to navigate to view one or both of the balance of their wallet (i.e., the number of Skill Coins remaining in the learner's wallet) or their skills wallet (i.e., the list of instructions which the learner had completed). Before the learner was granted access to their wallet or their skills wallet, an authentication procedure was initiated. Authentication was handled by generating a SHA256 hashed key with unique values from the learner, such as their Thinkific ID, the date, and their IP address. These were hashed with a private token in Liquid (the Thinkific Template engine). The hash and values used to create the hash were passed (without the private key) via GET variables.

If the learner was not an administrator, the learner was taken to a learner portal for Skill Coins. At this point, the learner could view a Leaderboard, Balance Sheets, or Dashboard. The Leaderboard allowed the learner to view how they rank against their peers in their training. The Balance Sheets allowed the learner to view their learning transcript and to do a deeper dive on their skills wallet, with an insight on the skills they possess (determined from which instructions the learner had completed) and how their skills compared with their peers. The Dashboard allowed the learner to view their position within their instruction regimen, their remaining Skill Coins balance, their skills wallet, and a mapping of their progress through the instruction regimen.

The learner could also request more Skill Coins if needed. To request more Skill Coins, the learner clicked on a button, which enabled them to enter the number of Skill Coins they needed. A request was then sent to an authorized member of the learner's company to approve or disapprove the request. If the authorized member approved the request, Skill Coins were added to the learner's wallet, allowing the learner to enroll in further instruction.

If, on the other hand, the learner was an administrator, the learner was taken to a company portal. The company portal allowed the learner to access the company wallet from which learner wallets were loaded with Skill Coins. Within the company portal, the learner could view the Leaderboard, Balance Sheets, and Dashboard described above. In addition, the company portal allowed the learner to view an administrator-only Insights view, which allowed the learner to view the skills of all learners within the cohort and to access the company wallet.

Within the company wallet, an administrator (including a learner with administrative access) could perform various transactions such as purchasing more Skill Coins for the company as a whole, allocating Skill Coins to various learners within the company, and approving and allocating Skill Coins requests originating from non-administrative learners within the company.

Although the foregoing embodiments have been described in some detail for purposes of clarity of understanding, the invention is not limited to the details provided. There are many alternative ways of implementing the invention. The disclosed embodiments are illustrative and not restrictive.

### RECITATION OF EMBODIMENTS

Embodiment 1. A computer-implemented method for enabling a teacher to provide instruction on a skill to a learner, comprising:
(a) receiving a request for the teacher to provide the instruction on the skill to the learner;
(b) in response to the request, debiting funds from a first funds wallet associated with the learner;
(c) permitting the teacher to provide the instruction to the learner; and
(d) depositing the funds into a second funds wallet associated with the teacher; wherein the teacher is a member of a first organization and the learner is a member of a second organization.

Embodiment 2. The computer-implemented method of Embodiment 1, wherein the first organization and the second organization are the same.

Embodiment 3. The computer-implemented method of Embodiment 1, wherein the first organization and the second organization are different.

Embodiment 4. The computer-implemented method of any one of Embodiments 1-3, wherein the request is received from the learner.

Embodiment 5. The computer-implemented method of any one of Embodiments 1-4, wherein the request is received from the second organization.

Embodiment 6. The computer-implemented method of any one of Embodiments 1-5, wherein (b) occurs before (c).

Embodiment 7. The computer-implemented method of any one of Embodiments 1-5, wherein (c) occurs before (b).

Embodiment 8. The computer-implemented method of Embodiment 6 or 7, wherein (c) occurs before (d).

Embodiment 9. The computer-implemented method of Embodiment 6 or 7, wherein (d) occurs before (c).

Embodiment 10. The computer-implemented method of any one of Embodiments 1-9, wherein the funds are associated with a digital currency, coin, or token.

Embodiment 11. The computer-implemented method of any one of Embodiments 1-10, wherein the funds are registered on a ledger.

Embodiment 12. The computer-implemented method of Embodiment 11, wherein the ledger comprises a decentralized ledger.

Embodiment 13. The computer-implemented method of any one of Embodiments 1-12, wherein the funds are associated with a card-based electronic funds transfer system.

Embodiment 14. The computer-implemented method of any one of Embodiments 1-13, wherein an amount of the funds debited from the first funds wallet and deposited to the second funds wallet is based at least in part on feedback regarding the instruction.

Embodiment 15. The computer-implemented method of any one of Embodiments 1-14, further comprising, prior to (a), displaying, to the learner, a list of available instructions, the list of available instructions comprising the instruction.

Embodiment 16. The computer-implemented method of Embodiment 15, further comprising receiving, from the learner, a selection of the instruction from the list of available instructions.

Embodiment 17. The computer-implemented method of any one of Embodiments 1-16, further comprising, prior to (a), displaying, to the learner, a list of available teachers, the list of available teachers comprising the teacher.

Embodiment 18. The computer-implemented method of Embodiment 17, further comprising receiving, from the learner, a selection of the teacher from the list of available teachers.

Embodiment 19. The computer-implemented method of any one of Embodiments 1-18, further comprising, subsequent to (c), including the instruction in a first skills wallet associated with the learner.

Embodiment 20. The computer-implemented method of Embodiment 19, further comprising displaying, to a member of the first organization or the second organization, the first skills wallet.

Embodiment 21. The computer-implemented method of Embodiment 19 or 20, further comprising displaying, to a member of the first organization or the second organization, a comparison between the first skills wallet and at least one second skills wallet associated with another member of the second organization.

Embodiment 22. The computer-implemented method of Embodiment 19 or 20, further comprising displaying, to a member of the first organization or the second organization, a metric associated with the first skills wallet, the metric based on a comparison between the first skills wallet and a plurality of other skills wallets.

Embodiment 23. A computer-implemented method for enabling a learner to receive instruction on a skill from a teacher, comprising:
(a) sending a request for the learner to receive the instruction on the skill from the teacher;
(b) in response to the request, debiting funds from a first funds wallet associated with the learner;
(c) permitting the learner to receive the instruction from the teacher; and
(d) depositing the funds into a second funds wallet associated with the teacher; wherein the teacher is a member of a first organization and the learner is a member of a second organization.

Embodiment 24. The computer-implemented method of Embodiment 23, wherein the first organization and the second organization are the same.

Embodiment 25. The computer-implemented method of Embodiment 23, wherein the first organization and the second organization are different.

Embodiment 26. The computer-implemented method of any one of Embodiments 23-25, wherein the request is sent by the learner.

Embodiment 27. The computer-implemented method of any one of Embodiments 23-26, wherein the request is sent by the second organization.

Embodiment 28. The computer-implemented method of any one of Embodiments 23-27, wherein (b) occurs before (c).

Embodiment 29. The computer-implemented method of any one of Embodiments 23-27, wherein (c) occurs before (b).

Embodiment 30. The computer-implemented method of Embodiment 28 or 29, wherein (c) occurs before (d).

Embodiment 31. The computer-implemented method of Embodiment 28 or 29, wherein (d) occurs before (c).

Embodiment 32. The computer-implemented method of any one of Embodiments 23-31, wherein the funds are associated with a digital currency, coin, or token.

Embodiment 33. The computer-implemented method of any one of Embodiments 23-32, wherein the funds are registered on a ledger.

Embodiment 34. The computer-implemented method of Embodiment 33, wherein the ledger comprises a decentralized ledger.

Embodiment 35. The computer-implemented method of any one of Embodiments 23-34, wherein the funds are associated with a card-based electronic funds transfer system.

Embodiment 36. The computer-implemented method of any one of Embodiments 23-35, wherein an amount of the funds debited from the first funds wallet and deposited to the second funds wallet is based at least in part on feedback regarding the instruction.

Embodiment 37. The computer-implemented method of any one of Embodiments 23-36, further comprising, prior to (a), displaying, to the learner, a list of available instructions, the list of available instructions comprising the instruction.

Embodiment 38. The computer-implemented method of Embodiment 37, further comprising sending, from the learner, a selection of the instruction from the list of available instructions.

Embodiment 39. The computer-implemented method of any one of Embodiments 23-38, further comprising, prior to (a), displaying, to the learner, a list of available teachers, the list of available teachers comprising the teacher.

Embodiment 40. The computer-implemented method of Embodiment 39, further comprising sending, from the learner, a selection of the teacher from the list of available teachers.

Embodiment 41. The computer-implemented method of any one of Embodiments 23-40, further comprising, subsequent to (c), including the instruction in a first skills wallet associated with the learner.

Embodiment 42. The computer-implemented method of Embodiment 41, further comprising displaying, to a member of the first organization or the second organization, the first skills wallet.

Embodiment 43. The computer-implemented method of Embodiment 41 or 42, further comprising displaying, to a member of the first organization or the second organization, a comparison between the first skills wallet and at least one second skills wallet associated with another member of the second organization.

Embodiment 44. The computer-implemented method of Embodiment 41 or 42, further comprising displaying, to a member of the first organization or the second organization, a metric associated with the first skills wallet, the metric based on a comparison between the first skills wallet and a plurality of other skills wallets.

Embodiment 45. A non-transitory machine-readable medium having stored thereon machine-readable instructions executable to cause a system to perform operations comprising:
(a) receiving a request for the teacher to provide the instruction on the skill to the learner;
(b) in response to the request, debiting funds from a first funds wallet associated with the learner;
(c) permitting the teacher to provide the instruction to the learner; and
(d) depositing the funds into a second funds wallet associated with the teacher; wherein the teacher is a member of a first organization and the learner is a member of a second organization.

Embodiment 46. The non-transitory machine-readable medium of Embodiment 45, wherein the first organization and the second organization are the same.

Embodiment 47. The non-transitory machine-readable medium of Embodiment 45, wherein the first organization and the second organization are different.

Embodiment 48. The non-transitory machine-readable medium of any one of Embodiments 45-47, wherein the request is received from the learner.

Embodiment 49. The non-transitory machine-readable medium of any one of Embodiments 45-48, wherein the request is received from the second organization.

Embodiment 50. The non-transitory machine-readable medium of any one of Embodiments 45-49, wherein (b) occurs before (c).

Embodiment 51. The non-transitory machine-readable medium of any one of Embodiments 45-49, wherein (c) occurs before (b).

Embodiment 52. The non-transitory machine-readable medium of Embodiment 50 or 51, wherein (c) occurs before (d).

Embodiment 53. The non-transitory machine-readable medium of Embodiment 50 or 51, wherein (d) occurs before (c).

Embodiment 54. The non-transitory machine-readable medium of any one of Embodiments 45-53, wherein the funds are associated with a digital currency, coin, or token.

Embodiment 55. The non-transitory machine-readable medium of any one of Embodiments 45-54, wherein the funds are registered on a ledger.

Embodiment 56. The non-transitory machine-readable medium of Embodiment 55, wherein the ledger comprises a decentralized ledger.

Embodiment 57. The non-transitory machine-readable medium of any one of Embodiments 45-56, wherein the funds are associated with a card-based electronic funds transfer system.

Embodiment 58. The non-transitory machine-readable medium of any one of Embodiments 45-57, wherein an amount of the funds debited from the first funds wallet and deposited to the second funds wallet is based at least in part on feedback regarding the instruction.

Embodiment 59. The non-transitory machine-readable medium of any one of Embodiments 45-58, wherein the operations further comprise, prior to (a), displaying, to the learner, a list of available instructions, the list of available instructions comprising the instruction.

Embodiment 60. The non-transitory machine-readable medium of Embodiment 59, wherein the operations further comprise receiving, from the learner, a selection of the instruction from the list of available instructions.

Embodiment 61. The non-transitory machine-readable medium of any one of Embodiments 45-60, wherein the operations further comprise, prior to (a), displaying, to the learner, a list of available teachers, the list of available teachers comprising the teacher.

Embodiment 62. The non-transitory machine-readable medium of Embodiment 61, wherein the operations further comprise receiving, from the learner, a selection of the teacher from the list of available teachers.

Embodiment 63. The non-transitory machine-readable medium of any one of Embodiments 45-62, wherein the operations further comprise, subsequent to (c), including the instruction in a first skills wallet associated with the learner.

Embodiment 64. The non-transitory machine-readable medium of Embodiment 63, wherein the operations further comprise displaying, to a member of the first organization or the second organization, the first skills wallet.

Embodiment 65. The non-transitory machine-readable medium of Embodiment 63 or 64, wherein the operations further comprise displaying, to a member of the first organization or the second organization, a comparison between the first skills wallet and at least one second skills wallet associated with another member of the second organization.

Embodiment 66. The non-transitory machine-readable medium of Embodiment 63 or 64, wherein the operations further comprise displaying, to a member of the first organization or the second organization, a metric associated with the first skills wallet, the metric based on a comparison between the first skills wallet and a plurality of other skills wallets.

Embodiment 67. A non-transitory machine-readable medium having stored thereon machine-readable instructions executable to cause a system to perform operations comprising:
(a) sending a request for the learner to receive the instruction on the skill from the teacher;
(b) in response to the request, debiting funds from a first funds wallet associated with the learner;
(c) permitting the leaner to receive the instruction from the teacher; and
(d) depositing the funds into a second funds wallet associated with the teacher;
(e) wherein the teacher is a member of a first organization and the learner is a member of a second organization.

Embodiment 68. The non-transitory machine-readable medium of Embodiment 67, wherein the first organization and the second organization are the same.

Embodiment 69. The non-transitory machine-readable medium of Embodiment 67, wherein the first organization and the second organization are different.

Embodiment 70. The non-transitory machine-readable medium of any one of Embodiments 67-69, wherein the request is sent by the learner.

Embodiment 71. The non-transitory machine-readable medium of any one of Embodiments 67-70, wherein the request is sent by the second organization.

Embodiment 72. The non-transitory machine-readable medium of any one of Embodiments 67-71, wherein (b) occurs before (c).

Embodiment 73. The non-transitory machine-readable medium of any one of Embodiments 67-71, wherein (c) occurs before (b).

Embodiment 74. The non-transitory machine-readable medium of Embodiment 72 or 73, wherein (c) occurs before (d).

Embodiment 75. The non-transitory machine-readable medium of Embodiment 72 or 73, wherein (d) occurs before (c).

Embodiment 76. The non-transitory machine-readable medium of any one of Embodiments 67-75, wherein the funds are associated with a digital currency, coin, or token.

Embodiment 77. The non-transitory machine-readable medium of any one of Embodiments 67-76, wherein the funds are registered on a ledger.

Embodiment 78. The non-transitory machine-readable medium of Embodiment 77, wherein the ledger comprises a decentralized ledger.

Embodiment 79. The non-transitory machine-readable medium of any one of Embodiments 67-78, wherein the funds are associated with a card-based electronic funds transfer system.

Embodiment 80. The non-transitory machine-readable medium of any one of Embodiments 67-79, wherein an amount of the funds debited from the first funds wallet and deposited to the second funds wallet is based at least in part on feedback regarding the instruction.

Embodiment 81. The non-transitory machine-readable medium of any one of Embodiments 67-80, wherein the operations further comprise, prior to (a), displaying, to the learner, a list of available instructions, the list of available instructions comprising the instruction.

Embodiment 82. The non-transitory machine-readable medium of Embodiment 81, wherein the operations further comprise sending, from the learner, a selection of the instruction from the list of available instructions.

Embodiment 83. The non-transitory machine-readable medium of any one of Embodiments 67-82, wherein the operations further comprise, prior to (a), displaying, to the learner, a list of available teachers, the list of available teachers comprising the teacher.

Embodiment 84. The non-transitory machine-readable medium of Embodiment 83, wherein the operations further comprise sending, from the learner, a selection of the teacher from the list of available teachers.

Embodiment 85. The non-transitory machine-readable medium of any one of Embodiments 67-84, wherein the operations further comprise, subsequent to (c), including the instruction in a first skills wallet associated with the learner.

Embodiment 86. The non-transitory machine-readable medium of Embodiment 85, wherein the operations further comprise displaying, to a member of the first organization or the second organization, the first skills wallet.

Embodiment 87. The non-transitory machine-readable medium of Embodiment 85 or 86, wherein the operations further comprise displaying, to a member of the first organization or the second organization, a comparison between the first skills wallet and at least one second skills wallet associated with another member of the second organization.

Embodiment 88. The non-transitory machine-readable medium of Embodiment 85 or 86, wherein the operations further comprise displaying, to a member of the first organization or the second organization, a metric associated with the first skills wallet, the metric based on a comparison between the first skills wallet and a plurality of other skills wallets.

Embodiment 89. A system comprising:
one or more processors configured to:
   (a) receive a request for the teacher to provide the instruction on the skill to the learner;
   (b) in response to the request, debit funds from a first funds wallet associated with the learner;
   (c) permit the teacher to provide the instruction to the learner; and
   (d) deposit the funds into a second funds wallet associated with the teacher; and
a memory coupled to the one or more processors and configured to provide the one or more processors with instructions corresponding to (a)-(d);
wherein the teacher is a member of a first organization and the learner is a member of a second organization.

Embodiment 90. The system of Embodiment 89, wherein the first organization and the second organization are the same.

Embodiment 91. The system of Embodiment 89, wherein the first organization and the second organization are different.

Embodiment 92. The system of any one of Embodiments 89-91, wherein the request is received from the learner.

Embodiment 93. The system of any one of Embodiments 89-92, wherein the request is received from the second organization.

Embodiment 94. The system of any one of Embodiments 89-93, wherein (b) occurs before (c).

Embodiment 95. The system of any one of Embodiments 89-93, wherein (c) occurs before (b).

Embodiment 96. The system of Embodiment 94 or 95, wherein (c) occurs before (d).

Embodiment 97. The system of Embodiment 94 or 95, wherein (d) occurs before (c).

Embodiment 98. The system of any one of Embodiments 89-97, wherein the funds are associated with a digital currency, coin, or token.

Embodiment 99. The system of any one of Embodiments 89-98, wherein the funds are registered on a ledger.

Embodiment 100. The system of Embodiment 99, wherein the ledger comprises a decentralized ledger.

Embodiment 101. The system of any one of Embodiments 89-100, wherein the funds are associated with a card-based electronic funds transfer system.

Embodiment 102. The system of any one of Embodiments 89-101, wherein an amount of the funds debited from the first funds wallet and deposited to the second funds wallet is based at least in part on feedback regarding the instruction.

Embodiment 103. The system of any one of Embodiments 89-102, wherein the one or more processors are further configured to, prior to (a), display, to the learner, a list of available instructions, the list of available instructions comprising the instruction and wherein the memory is further configured to provide the one or more processors with instructions to, prior to (a), display, to the learner, the list of available instructions.

Embodiment 104. The system of Embodiment 103, wherein the one or more processors are further configured to receive, from the learner, a selection of the instruction from the list of available instructions and wherein the memory is further configured to provide the one or more processors with instructions to receive, from the learner, the selection of the instruction.

Embodiment 105. The system of any one of Embodiments 89-104, wherein the one or more processors are further configured to, prior to (a), display, to the learner, a list of available teachers, the list of available teachers comprising the teacher and wherein the memory is further configured to provide the one or more processors with instructions to, prior to (a), display, to the learner, the list of available teachers.

Embodiment 106. The system of Embodiment 105, wherein the one or more processors are further configured to receive, from the learner, a selection of the teacher from the list of available teachers and wherein the memory is further configured to provide the one or more processors with instructions to receive, from the learner, the selection of the teacher.

Embodiment 107. The system of any one of Embodiments 89-106, wherein the one or more processors are further configured to, subsequent to (c), include the instruction in a first skills wallet associated with the learner and wherein the memory is further configured to provide the one or more processors with instructions to, subsequent to (c), include the instruction in the first skills wallet.

Embodiment 108. The system of Embodiment 107, wherein the one or more processors are further configured to display, to a member of the first organization or the second organization, the first skills wallet and wherein the memory is further configured to provide the one or more processors with instructions to display, to the member of the first organization or the second organization, the first skills wallet.

Embodiment 109. The system of Embodiment 107 or 108, wherein the one or more processors are further configured to display, to a member of the first organization or the second organization, a comparison between the first skills wallet and at least one second skills wallet associated with another member of the second organization and wherein the memory is further configured to provide the one or more processors with instructions to display, to the member of the first organization or the second organization, the comparison.

Embodiment 110. The system of Embodiment 107 or 108, wherein the one or more processors are further configured to display, to a member of the first organization or the second organization, a metric associated with the first skills wallet, the metric based on a comparison between the first skills wallet and a plurality of other skills wallets and wherein the memory is further configured to provide the one or more processors with instructions to display, to a member of the first organization or the second organization, the metric.

Embodiment 111. A system comprising:
one or more processors configured to:
   (a) send a request for the learner to receive the instruction on the skill from the teacher;
   (b) in response to the request, debit funds from a first funds wallet associated with the learner;
   (c) permit the leaner to receive the instruction from the teacher; and
   (d) deposit the funds into a second funds wallet associated with the teacher; and
a memory coupled to the one or more processors and configured to provide the one or more processors with instructions corresponding to (a)-(d);
wherein the teacher is a member of a first organization and the learner is a member of a second organization.

Embodiment 112. The system of Embodiment 111, wherein the first organization and the second organization are the same.

Embodiment 113. The system of Embodiment 111, wherein the first organization and the second organization are different.

Embodiment 114. The system of any one of Embodiments 111-113, wherein the request is sent by the learner.

Embodiment 115. The system of any one of Embodiments 111-114, wherein the request is sent by the second organization.

Embodiment 116. The system of any one of Embodiments 111-115, wherein (b) occurs before (c).

Embodiment 117. The system of any one of Embodiments 111-115, wherein (c) occurs before (b).

Embodiment 118. The system of Embodiment 116 or 117, wherein (c) occurs before (d).

Embodiment 119. The system of Embodiment 116 or 117, wherein (d) occurs before (c).

Embodiment 120. The system of any one of Embodiments 111-119, wherein the funds are associated with a digital currency, coin, or token.

Embodiment 121. The system of any one of Embodiments 111-120, wherein the funds are registered on a ledger.

Embodiment 122. The system of Embodiment 121, wherein the ledger comprises a decentralized ledger.

Embodiment 123. The system of any one of Embodiments 111-122, wherein the funds are associated with a card-based electronic funds transfer system.

Embodiment 124. The system of any one of Embodiments 111-123, wherein an amount of the funds debited from the first funds wallet and deposited to the second funds wallet is based at least in part on feedback regarding the instruction.

Embodiment 125. The system of any one of Embodiments 111-124, wherein the one or more processors are further configured to, prior to (a), display, to the learner, a list of available instructions, the list of available instructions comprising the instruction and wherein the memory is further configured to provide the one or more processors with instructions to, prior to (a), display, to the learner, the list of available instructions.

Embodiment 126. The system of Embodiment 125, wherein the one or more processors are further configured to send, from the learner, a selection of the instruction from the list of available instructions and wherein the memory is further configured to provide the one or more processors with instructions to send, from the learner, the selection of the instruction.

Embodiment 127. The system of any one of Embodiments 111-126, wherein the one or more processors are further configured to, prior to (a), display, to the learner, a list of available teachers, the list of available teachers comprising the teacher and wherein the memory is further configured to provide the one or more processors with instructions to, prior to (a), display, to the learner, the list of available teachers.

Embodiment 128. The system of Embodiment 127, wherein the one or more processors are further configured to send, from the learner, a selection of the teacher from the list of available teachers and wherein the memory is further configured to provide the one or more processors with instructions to send, from the learner, the selection of the teacher.

Embodiment 129. The system of any one of Embodiments 111-128, wherein the one or more processors are further configured to, subsequent to (c), include the instruction in a first skills wallet associated with the learner and wherein the memory is further configured to provide the one or more processors with instructions to, subsequent to (c), include the instruction in the first skills wallet.

Embodiment 130. The system of Embodiment 129, wherein the one or more processors are further configured to display, to a member of the first organization or the second organization, the first skills wallet and wherein the memory is further configured to provide the one or more processors with instructions to display, to the member of the first organization or the second organization, the first skills wallet.

Embodiment 131. The system of Embodiment 129 or 130, wherein the one or more processors are further configured to display, to a member of the first organization or the second organization, a comparison between the first skills wallet and at least one second skills wallet associated with another member of the second organization and wherein the memory is further configured to provide the one or more processors with instructions to display, to the member of the first organization or the second organization, the comparison.

Embodiment 132. The system of Embodiment 129 or 130, wherein the one or more processors are further configured to display, to a member of the first organization or the second organization, a metric associated with the first skills wallet, the metric based on a comparison between the first skills wallet and a plurality of other skills wallets and wherein the memory is further configured to provide the one or more processors with instructions to display, to a member of the first organization or the second organization, the metric.

Embodiment 133. A system comprising:
one or more processors; and
a memory coupled to the one or more processors and configured to provide the one or more processors with instructions which when executed cause the one or more processors to:
   (a) receive a request for teacher to provide the instruction on the skill to the learner;
   (b) in response to the request, debit funds from a first funds wallet associated with the learner;
   (c) permit the teacher to provide the instruction to the learner; and
   (d) deposit the funds into a second funds wallet associated with the teacher;
      wherein the teacher is a member of a first organization and the learner is a member of a second organization.

Embodiment 134. The system of Embodiment 133, wherein the first organization and the second organization are the same.

Embodiment 135. The system of Embodiment 133, wherein the first organization and the second organization are different.

Embodiment 136. The system of any one of Embodiments 133-135, wherein the request is received from the learner.

Embodiment 137. The system of any one of Embodiments 133-136, wherein the request is received from the second organization.

Embodiment 138. The system of any one of Embodiments 133-137, wherein (b) occurs before (c).

Embodiment 139. The system of any one of Embodiments 133-137, wherein (c) occurs before (b).

Embodiment 140. The system of Embodiment 138 or 139, wherein (c) occurs before (d).

Embodiment 141. The system of Embodiment 138 or 139, wherein (d) occurs before (c).

Embodiment 142. The system of any one of Embodiments 133-141, wherein the funds are associated with a digital currency, coin, or token.

Embodiment 143. The system of any one of Embodiments 133-142, wherein the funds are registered on a ledger.

Embodiment 144. The system of Embodiment 143, wherein the ledger comprises a decentralized ledger.

Embodiment 145. The system of any one of Embodiments 133-144, wherein the funds are associated with a card-based electronic funds transfer system.

Embodiment 146. The system of any one of Embodiments 133-145, wherein an amount of the funds debited from the first funds wallet and deposited to the second funds wallet is based at least in part on feedback regarding the instruction.

Embodiment 147. The system of any one of Embodiments 133-146, wherein the memory is further configured to provide the one or more processors with instructions which when executed cause the one or more processors to, prior to (a), display, to the learner, a list of available instructions, the list of available instructions comprising the instruction.

Embodiment 148. The system of Embodiment 147, wherein the memory is further configured to provide the one or more processors with instructions which when executed cause the one or more processors to receive, from the learner, a selection of the instruction from the list of available instructions.

Embodiment 149. The system of any one of Embodiments 133-148, wherein the memory is further configured to provide the one or more processors with instructions which when executed cause the one or more processors to, prior to (a), display, to the learner, a list of available teachers, the list of available teachers comprising the teacher.

Embodiment 150. The system of Embodiment 149, wherein the memory is further configured to provide the one or more processors with instructions which when executed cause the one or more processors to receive, from the learner, a selection of the teacher from the list of available teachers.

Embodiment 151. The system of any one of Embodiments 133-150, wherein the memory is further configured to provide the one or more processors with instructions which when executed cause the one or more processors to, subsequent to (c), include the instruction in a first skills wallet associated with the learner.

Embodiment 152. The system of Embodiment 151, wherein the memory is further configured to provide the one or more processors with instructions which when executed cause the one or more processors to display, to a member of the first organization or the second organization, the first skills wallet.

Embodiment 153. The system of Embodiment 151 or 152, wherein the memory is further configured to provide the one or more processors with instructions which when executed cause the one or more processors to display, to a member of the first organization or the second organization, a comparison between the first skills wallet and at least one second skills wallet associated with another member of the second organization.

Embodiment 154. The system of Embodiment 151 or 152, wherein the memory is further configured to provide the one or more processors with instructions which when executed cause the one or more processors to display, to a member of the first organization or the second organization, a metric associated with the first skills wallet, the metric based on a comparison between the first skills wallet and a plurality of other skills wallets.

Embodiment 155. A system comprising:
one or more processors; and
a memory coupled to the one or more processors and configured to provide the one or more processors with instructions which when executed cause the one or more processors to:
   (a) send a request for learner to receive the instruction on the skill from the teacher;
   (b) in response to the request, debit funds from a first funds wallet associated with the learner;
   (c) permit the learner to receive the instruction from the learner; and
   (d) deposit the funds into a second funds wallet associated with the teacher;
      wherein the teacher is a member of a first organization and the learner is a member of a second organization.

Embodiment 156. The system of Embodiment 155, wherein the first organization and the second organization are the same.

Embodiment 157. The system of Embodiment 155, wherein the first organization and the second organization are different.

Embodiment 158. The system of any one of Embodiments 155-157, wherein the request is sent by the learner.

Embodiment 159. The system of any one of Embodiments 155-158, wherein the request is sent by the second organization.

Embodiment 160. The system of any one of Embodiments 155-159, wherein (b) occurs before (c).

Embodiment 161. The system of any one of Embodiments 155-159, wherein (c) occurs before (b).

Embodiment 162. The system of Embodiment 160 or 161, wherein (c) occurs before (d).

Embodiment 163. The system of Embodiment 160 or 161, wherein (d) occurs before (c).

Embodiment 164. The system of any one of Embodiments 155-163, wherein the funds are associated with a digital currency, coin, or token.

Embodiment 165. The system of any one of Embodiments 155-164, wherein the funds are registered on a ledger.

Embodiment 166. The system of Embodiment 165, wherein the ledger comprises a decentralized ledger.

Embodiment 167. The system of any one of Embodiments 155-166, wherein the funds are associated with a card-based electronic funds transfer system.

Embodiment 168. The system of any one of Embodiments 155-167, wherein an amount of the funds debited from the first funds wallet and deposited to the second funds wallet is based at least in part on feedback regarding the instruction.

Embodiment 169. The system of any one of Embodiments 155-168, wherein the memory is further configured to provide the one or more processors with instructions which when executed cause the one or more processors to, prior to (a), display, to the learner, a list of available instructions, the list of available instructions comprising the instruction.

Embodiment 170. The system of Embodiment 169, wherein the memory is further configured to provide the one or more processors with instructions which when executed cause the one or more processors to send, from the learner, a selection of the instruction from the list of available instructions.

Embodiment 171. The system of any one of Embodiments 155-170, wherein the memory is further configured to provide the one or more processors with instructions which when executed cause the one or more processors to, prior to (a), display, to the learner, a list of available teachers, the list of available teachers comprising the teacher.

Embodiment 172. The system of Embodiment 171, wherein the memory is further configured to provide the one or more processors with instructions which when executed cause the one or more processors to send, from the learner, a selection of the teacher from the list of available teachers.

Embodiment 173. The system of any one of Embodiments 155-172, wherein the memory is further configured to provide the one or more processors with instructions which when executed cause the one or more processors to, subsequent to (c), include the instruction in a first skills wallet associated with the learner.

Embodiment 174. The system of Embodiment 173, wherein the memory is further configured to provide the one or more processors with instructions which when executed cause the one or more processors to display, to a member of the first organization or the second organization, the first skills wallet.

Embodiment 175. The system of Embodiment 173 or 174, wherein the memory is further configured to provide the one or more processors with instructions which when executed cause the one or more processors to display, to a member of the first organization or the second organization, a comparison between the first skills wallet and at least one second skills wallet associated with another member of the second organization.

Embodiment 176. The system of Embodiment 173 or 174, wherein the memory is further configured to provide the one or more processors with instructions which when executed cause the one or more processors to display, to a member of the first organization or the second organization, a metric associated with the first skills wallet, the metric based on a comparison between the first skills wallet and a plurality of other skills wallets.

Embodiment 177. A system comprising:
a communications module configured to: (a) receive a request for the teacher to provide the instruction on the skill to the learner;
a credit module configured to: (b) in response to the request, debit funds from a first funds wallet associated with the learner and (d) deposit the funds into a second funds wallet associated with the teacher; and
an access module configured to: (c) permit the teacher to provide the instruction to the learner;
wherein the teacher is a member of a first organization and the learner is a member of a second organization.

Embodiment 178. The system of Embodiment 177, wherein the first organization and the second organization are the same.

Embodiment 179. The system of Embodiment 177, wherein the first organization and the second organization are different.

Embodiment 180. The system of any one of Embodiments 177-179, wherein the request is received from the learner.

Embodiment 181. The system of any one of Embodiments 177-180, wherein the request is received from the second organization.

Embodiment 182. The system of any one of Embodiments 177-181, wherein (b) occurs before (c).

Embodiment 183. The system of any one of Embodiments 177-181, wherein (c) occurs before (b).

Embodiment 184. The system of Embodiment 182 or 183, wherein (c) occurs before (d).

Embodiment 185. The system of Embodiment 182 or 183, wherein (d) occurs before (c).

Embodiment 186. The system of any one of Embodiments 177-185, wherein the funds are associated with a digital currency, coin, or token.

Embodiment 187. The system of any one of Embodiments 177-186, wherein the funds are registered on a ledger.

Embodiment 188. The system of Embodiment 187, wherein the ledger comprises a decentralized ledger.

Embodiment 189. The system of any one of Embodiments 177-188, wherein the funds are associated with a card-based electronic funds transfer system.

Embodiment 190. The system of any one of Embodiments 177-189, wherein an amount of the funds debited from the first funds wallet and deposited to the second funds wallet is based at least in part on feedback regarding the instruction.

Embodiment 191. The system of any one of Embodiments 177-190, further comprising a display module configured to, prior to (a), display, to the learner, a list of available instructions, the list of available instructions comprising the instruction.

Embodiment 192. The system of Embodiment 191, wherein the communications module is further configured to receive, from the learner, a selection of the instruction from the list of available instructions.

Embodiment 193. The system of any one of Embodiments 177-192, wherein the display module is further configured to, prior to (a), display, to the learner, a list of available teachers, the list of available teachers comprising the teacher.

Embodiment 194. The system of Embodiment 193, wherein the communications module is further configured to receive, from the learner, a selection of the teacher from the list of available teachers.

Embodiment 195. The system of any one of Embodiments 177-194, further comprising a skills module configured to, subsequent to (c), include the instruction in a first skills wallet associated with the learner.

Embodiment 196. The system of Embodiment 195, wherein the skills module is further configured to display, to a member of the first organization or the second organization, the first skills wallet.

Embodiment 197. The system of Embodiment 195 or 196, wherein the skills module is further configured to display, to a member of the first organization or the second organization, a comparison between the first skills wallet and at least one second skills wallet associated with another member of the second organization.

Embodiment 198. The system of Embodiment 195 or 196, wherein the skills module is further configured to display, to a member of the first organization or the second organization, a metric associated with the first skills wallet, the metric based on a comparison between the first skills wallet and a plurality of other skills wallets.

Embodiment 199. A system comprising:
a communications module configured to: (a) send a request for the learner to receive the instruction on the skill from the teacher;
a credit module configured to: (b) in response to the request, debit funds from a first funds wallet associated with the learner and (d) deposit the funds into a second funds wallet associated with the teacher; and
an access module configured to: (c) permit the learner to receive the instruction from the teacher;
wherein the teacher is a member of a first organization and the learner is a member of a second organization.

Embodiment 200. The system of Embodiment 199, wherein the first organization and the second organization are the same.

Embodiment 201. The system of Embodiment 199, wherein the first organization and the second organization are different.

Embodiment 202. The system of any one of Embodiments 199-201, wherein the request is sent by the learner.

Embodiment 203. The system of any one of Embodiments 199-202, wherein the request is sent by the second organization.

Embodiment 204. The system of any one of Embodiments 199-203, wherein (b) occurs before (c).

Embodiment 205. The system of any one of Embodiments 199-203, wherein (c) occurs before (b).

Embodiment 206. The system of Embodiment 204 or 205, wherein (c) occurs before (d).

Embodiment 207. The system of Embodiment 204 or 205, wherein (d) occurs before (c).

Embodiment 208. The system of any one of Embodiments 199-207, wherein the funds are associated with a digital currency, coin, or token.

Embodiment 209. The system of any one of Embodiments 199-208, wherein the funds are registered on a ledger.

Embodiment 210. The system of Embodiment 209, wherein the ledger comprises a decentralized ledger.

Embodiment 211. The system of any one of Embodiments 199-210, wherein the funds are associated with a card-based electronic funds transfer system.

Embodiment 212. The system of any one of Embodiments 199-211, wherein an amount of the funds debited from the first funds wallet and deposited to the second funds wallet is based at least in part on feedback regarding the instruction.

Embodiment 213. The system of any one of Embodiments 199-212, further comprising a display module configured to, prior to (a), display, to the learner, a list of available instructions, the list of available instructions comprising the instruction.

Embodiment 214. The system of Embodiment 213, wherein the communications module is further configured to send, from the learner, a selection of the instruction from the list of available instructions.

Embodiment 215. The system of any one of Embodiments 199-214, wherein the display module is further configured to, prior to (a), display, to the learner, a list of available teachers, the list of available teachers comprising the teacher.

Embodiment 216. The system of Embodiment 215, wherein the communications module is further configured to send, from the learner, a selection of the teacher from the list of available teachers.

Embodiment 217. The system of any one of Embodiments 199-216, further comprising a skills module configured to, subsequent to (c), include the instruction in a first skills wallet associated with the learner.

Embodiment 218. The system of Embodiment 217, wherein the skills module is further configured to display, to a member of the first organization or the second organization, the first skills wallet.

Embodiment 219. The system of Embodiment 217 or 218, wherein the skills module is further configured to display, to a member of the first organization or the second organization, a comparison between the first skills wallet and at least one second skills wallet associated with another member of the second organization.

Embodiment 220. The system of Embodiment 217 or 218, wherein the skills module is further configured to display, to a member of the first organization or the second organization, a metric associated with the first skills wallet, the metric based on a comparison between the first skills wallet and a plurality of other skills wallets.

1. A computer-implemented method for enabling a teacher to provide instruction on a skill to a learner, comprising:
(a) receiving a request for the teacher to provide the instruction on the skill to the learner;
(b) in response to the request, debiting funds from a first funds wallet associated with the learner;
(c) permitting the teacher to provide the instruction to the learner; and
(d) depositing the funds into a second funds wallet associated with the teacher; wherein the teacher is a member of a first organization and the learner is a member of a second organization.

2. The computer-implemented method of claim 1, wherein the first organization and the second organization are the same.

3. The computer-implemented method of claim 1, wherein the first organization and the second organization are different.

4. The computer-implemented method of claim 1, wherein the request is received from the learner.

5. The computer-implemented method of claim 1, wherein the request is received from the second organization.

6. The computer-implemented method of claim 1, wherein (b) occurs before (c).

7. The computer-implemented method of claim 1, wherein (c) occurs before (b).

8. The computer-implemented method of claim 1, wherein (c) occurs before (d).

9. The computer-implemented method of claim 1, wherein (d) occurs before (c).

10. The computer-implemented method of claim 1, wherein the funds are associated with a digital currency, coin, or token.

11. The computer-implemented method of claim 1, wherein the funds are registered on a ledger.

12. The computer-implemented method of claim 11, wherein the ledger comprises a decentralized ledger.

13. The computer-implemented method of claim 1, wherein the funds are associated with a card-based electronic funds transfer system.

14. The computer-implemented method of claim 1, wherein an amount of the funds debited from the first funds wallet and deposited to the second funds wallet is based at least in part on feedback regarding the instruction.

15. The computer-implemented method of claim 1, further comprising, prior to (a), displaying, to the learner, a list of available instructions, the list of available instructions comprising the instruction.

16. The computer-implemented method of claim 15, further comprising receiving, from the learner, a selection of the instruction from the list of available instructions.

17. The computer-implemented method of claim 1, further comprising, prior to (a), displaying, to the learner, a list of available teachers, the list of available teachers comprising the teacher.

18. The computer-implemented method of claim 17, further comprising receiving, from the learner, a selection of the teacher from the list of available teachers.

19. The computer-implemented method of claim 1, further comprising, subsequent to (c), including the instruction in a first skills wallet associated with the learner.

20. The computer-implemented method of claim 19, further comprising displaying, to a member of the first organization or the second organization, the first skills wallet.

21. The computer-implemented method of claim 19, further comprising displaying, to a member of the first organization or the second organization, a comparison between the first skills wallet and at least one second skills wallet associated with another member of the second organization.

22. The computer-implemented method of claim 19, further comprising displaying, to a member of the first organization or the second organization, a metric associated with the first skills wallet, the metric based on a comparison between the first skills wallet and a plurality of other skills wallets.
